(19) United States
(12) Patent Application Publication
(10) Pub. No.: US 2004/0185888 A1
(43) Pub. Date: Sep. 23, 2004

(54) Solving mobile station identity in a multi-SIM situation

(75) Inventor: Haumont Serge, Helsinki (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/391,463

(22) Filed: Mar. 18, 2003

(51) Int. Cl. H04Q 7/20

(52) U.S. Cl. 455/517; 455/551; 455/558

(57) ABSTRACT

A method and system are disclosed for contacting a user having a plurality of mobile stations that share at least one common mobile station integrated services digital network number (MSISDN). Contact instructions include respective addresses for two or more of the user's mobile stations, if there has been an attempt to contact a single address that is among one or more common addresses.

### TECHNICAL FIELD OF THE INVENTION

The present invention relates to wireless telecommunications systems, and more particularly to multiple mobile stations having a common caller line identity.

### BACKGROUND ART

It is sometimes beneficial for a single wireless user to have multiple subscriber identity modules (SIM's). In that case, the user may have multiple mobile stations (MS), for example one on his person and one in his car. Both of the user's mobile stations answer calls addressed to the user's mobile station integrated services digital network number (MSISDN). A SIM card can be inserted into every MS owned by the user, each SIM card having its own international mobile subscriber identity (IMSI) and its own MSISDN (“own-MSISDN”). The phone number used by the user is called a “common-MSISDN” which would be the one visible to all of the user's contacts (via calling line identity) and which would also be used to call/send short messages to the user.

The SIM card for the user's primary MS would usually have only the common-MSISDN, whereas the user's SIM cards for non-primary phones would have both the common-MSISDN plus a respective own-MSISDN. Typically, for the primary phone, the common-MSISDN would typically also serve as the primary phone's own-MSISDN.

A short message service (SMS) can be handled by having the short messages sent to the common-MSISDN, and then the short messages proceed to the primary phone only. Non-primary phones will receive SMS only if the short messages are specifically sent to their own-MSISDN. For other types of communications, that often use SMS as a bearer (e.g. wireless application protocol-push, SIM application tool kit, remote configuration), there exists a problem of how to reach the right phone and not just the primary phone.

A typical prior art communications system includes a public land mobile network (PLMN), as detailed in FIG. 1. The user equipment (UE) on the left-hand-side interacts with a universal mobile telecommunications system (UMTS) terrestrial radio access network (UTRAN) via a radio interface called a Uu interface. The UE includes a UMTS subscriber identity module (USIM) that interacts with the rest of the mobile equipment (ME) via an electrical interface called a Cu interface. The UTRAN includes a plurality of Node B's which are base stations that interact with radio network controllers (RNC's) via an open interface called an Iub interface. An open Iur interface allows handover between RNC's. The UTRAN interacts with a core network (CN) via an Iu interface.

Within the core network, a home location register (HLR) is located in the user's home system and stores the master copy of the subscriber's service profile. A mobile services switching center and visitor location register is the switch (MSC) and database (VLR) that serves the UE for circuit switched services. A gateway MSC (GMSC) is a switch at the point where the PLMN connects to external circuit switched systems. A serving general packet radio service (GPRS) support node (SGSN) is similar to the MSC/VLR but is typically used for packet switched services instead of circuit switched services. Finally, the core network shown in FIG. 1 also includes a gateway GPRS support node (GGSN) to connect the internet protocol network. The core network (CN) interacts with external networks, as shown in FIG. 1.

For the purpose of dealing with incoming communications to a user, the home location register (HLR) in the user's home system will direct a connection received with the common-MSISDN to the primary phone.

For the purpose of dealing with outgoing communications, the home location register (HLR) provides the subscriber's common-MSISDN, and possibly the own-MSISDN's, to the serving system (e.g. MSC/VLR or SGSN) where the subscriber is attached. During outgoing communications, the serving system uses the common MSISDN in the calling-line-identity field. This feature is sometimes referred to as the “same-CLI” feature, and may not be supported by all serving systems. If the serving system does support this same-CLI feature, then the serving system will usually receive only an own-MSISDN, and this own-MSISDN is used in the calling-line-identity field.

Let us take an example where SGSN does not support this feature, and consider an internet protocol (IP) functionality where MMS is delivered via Push-over-IP, the Push-over-IP being supported by a wireless application protocol (WAP) gateway/proxy. This important and useful type of functionality is inconsistent with the same-CLI feature, for the following reason. When a packet data protocol (PDP) context is activated, the GGSN sends a remote authentication dial-in user service (RADIUS) message to a database, such as a subscriber identity register (SIR), which stores the relation between MSISDN, IMSI, and dynamic IP address. The push proxy receives from a push initiator, e.g. from a multimedia messaging service center (MMSC), a request to push a message to a common-MSISDN. The push proxy then queries the SIR about the common-MSISDN, in order to get the MS IP address. The push proxy then sends the push message to the MS IP address. It is expected that the MSISDN known by the push initiator is the common-MSISDN. However, because SGSN does not support the same-CLI feature, it will always provide the own-MSISDN to the GGSN, which then provides that own-MSISDN to the SIR. The query from the push proxy to the SIR will then fail except if, for the primary MS, the common-MSISDN is the same as the own-MSISDN.

Thus, the push message will always reach the primary MS (similar to SMS), but will not normally reach any other MS belonging to the user. Furthermore, this will be true for MMS, which is a particular type of push message. An especially problematic case would be a user buying an MMS phone not configured as a primary MS. This user will never be able to receive MMS at all, if that is his only wireless phone.

Even if, SGSN does support the same-CLI feature, it can send only one MSISDN to the GGSN based upon the 3GPP standard. It could then provide a common-MSISDN to GGSN for packet data protocol contexts established with either primary or non-primary MS, and then the SIR would very possibly have a problem choosing among multiple IP addresses.

The central problem of the existing art is how to push a message to a subscriber having multiple phone and/or multiple SIM features. The existing art allows only pushing to a primary phone, which is quite restrictive. In addition, this problem will not necessarily be solved for push-over-IP even if SGSN someday supports the same-CLI feature, because, for example, the SIR would still be left with the problem of choosing among multiple IP addresses.

These problems of the existing art have also not been solved for mobile terminated (MT) SMS, which currently reach only the primary MS. Offering operator and subscriber flexibility on how to distribute SMS to a multi SIM user would therefore be quite useful as well.

### DISCLOSURE OF THE INVENTION

The invention consists in a method for a push proxy/messaging center to query a profile server before pushing a message to an MS, the profile server being adapted to return both a list of MS addresses (IP addresses, MSISDNs) to be used to push the message, as well as indications or rules regarding how to push the message, and furthermore the profile server will optionally return MS capabilities.

These rules provided by the profile server may indicate that the push proxy/messaging center must push to all MS's in the list, or that the push proxy/messaging center must send a notification to all MS's in the list but allow only one device to download the push message, or may indicate that push messages or notifications must be sent to every phone successively until one of the MS's answers, at which time any outstanding push notifications could be erased.

In a preferred embodiment, the query from the push proxy/messaging center to the profile server will indicate the service used (e.g. MMS), and the profile server will check the service capability of the various MS, and send back to the push proxy/messaging center only information about the MS's which support that service. Also, the profile server will check the connection status of the various MS, and send back only the IP addresses of MS's that are connected.

The profile server may also have a rule that if a query is made by the push proxy/messaging center regarding an own-MSISDN of a secondary MS, then the push message is to be sent only to that secondary MS.

Although the focus of the present invention is on push proxy/messaging center, its main idea could alternatively be applicable to SMS, in which case the HLR could comprise a profile server. This invention alternatively could be applicable to Session Initiation Protocol (SIP), in which case a Home Subscriber Server (HSS) could comprise a profile server.

The novelty of the present invention thus consists primarily in receiving a request to send information to a single MS, and returning multiple MS's to be contacted, preferably with associated information regarding how to contact them. This method offers much more flexibility than just pushing only to a primary MS.

According to one aspect of this method for communicating with at least one of a plurality of mobile stations that share at least one common address, a query regarding a single address is received, then contact instructions are returned for contacting the at least one of the plurality of mobile stations in response to the query, and then contact is made according to the contact instructions. If the single address is among the at least one common address, then the contact instructions include respective addresses for two or more mobile stations.

According to another aspect of this method of providing a push message to a collection of mobile terminals having a common subscriber, a push message signal indicates a push message for delivery to the collection of mobile terminals, a rules query signal is sent in response to the push message signal, a delivery rules signal is provided in response to the rules query signal, and a push notification signal is sent to at least one of the mobile terminals, in response to, and in a manner consistent with rules prescribed by, the delivery rules signal.

The present invention also discloses a system for communicating with at least one of a plurality of mobile stations that share a common address. The system comprises a proxy, for sending a query regarding a single address, and a profile server, responsive to the query, for determining whether said single address is the common address, and if so returning contact instructions for contacting the at least one of the plurality of mobile stations that share said common address. The proxy is also for contacting the at least one of the plurality of mobile stations, in response to the contact instructions.

According to another aspect of such a system, the system is for providing a message to a collection of mobile terminals having a common subscriber. The system comprises an initiator, for providing a message signal indicative of a message targeted toward a common address. The system also comprises a proxy, responsive to the message signal, for sending a rules query signal. The system further comprises a profile server, responsive to the rules query signal, for providing delivery rules or mobile station capability or both. The proxy is also for delivering the message to at least one of the mobile terminals, in response to, and in a manner consistent with, rules prescribed by the delivery rules or the mobile station capability or both.

### BRIEF DESCRIPTION OF THE DRAWINGS

FIG. 1 shows a diagram of a prior art architecture for a public land mobile network.

FIG. 2 illustrates a pushing system according to the present claimed invention.

FIG. 3 is a flow chart exemplifying a best mode embodiment of the present claimed invention.

FIG. 4 is another flow chart describing another best mode embodiment.

FIG. 5 illustrates a proxy such as a push proxy.

FIG. 6 illustrates a profile server.

FIG. 7 illustrates proxy software.

FIG. 8 illustrates profile server software.

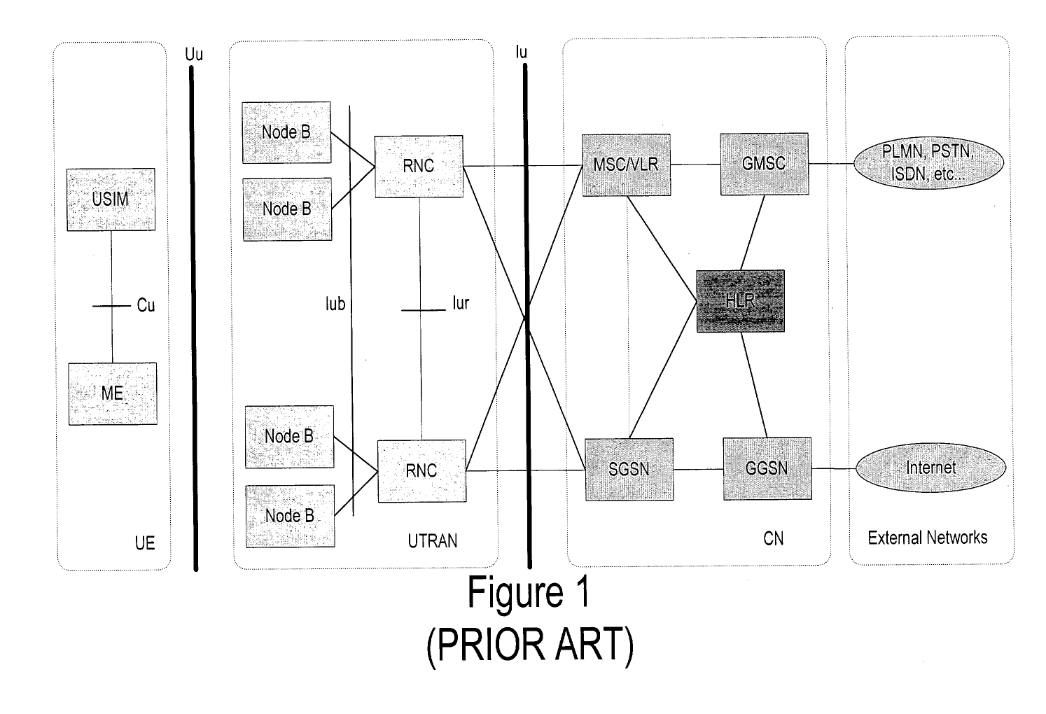

### BEST MODE FOR CARRYING OUT THE INVENTION

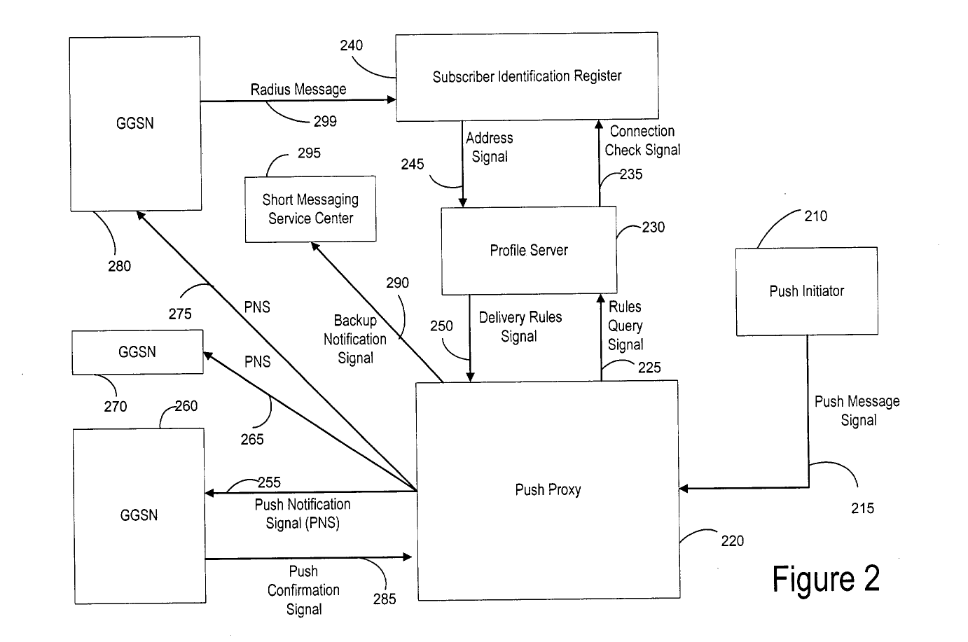

FIG. 2 depicts a preferred delivery system for a push message. The drawing depicts a push initiator 210, and a push proxy 220 capable of reaching an MS through an IP address via GGSN 260 or alternatively through an MSISDN via SMSC 295. FIG. 2 shows several GGSN's 260, 270, and 280 to reflect the idea that different mobile stations may be connected to different GGSN's. This system shown in FIG. 2 fits within the context of the push model standardized by the Wireless Application Protocol (WAP) forum and Open Mobile Alliance (OMA).

In addition, FIG. 2 depicts a database called a Subscriber Identity Register (SIR 240) which is updated by each GGSN 260, 270, 280 which sends a remote authentication dial-in user service (RADIUS) message 299 each time an MS activates or deactivates a packet data protocol (PDP) context. Note that, to simplify FIG. 2, not all links are shown. The SIR 240 is typically acting as a RADIUS proxy. The SIR always knows the relation between an MS, MSISDN, and IP address.

FIG. 2 also depicts a profile server 230, which can access subscriber information (e.g. a relation between a common and an own-MSISDN, or push delivery logic), MS capability, as well as information contained in the SIR 240.

According to this embodiment of the present invention, the push initiator 210 (e.g. a multimedia messaging service center MMSC) sends a push message 215 to be delivered to an MSISDN. Then, the push proxy 220 sends a rules query signal 225 containing the MSISDN to a profile server 230. The profile server 230 checks the profile of the subscriber, and in particular if the subscriber is a multiple SIM subscriber.

The profile server 230 then checks how to deliver a message to a multi-SIM subscriber. For example, the delivery may be only to primary MS. Or, notification may be to all MS's, but delivery only to the first MS that answers. Or, delivery may be only to MS's that are connected and have IP addresses, but if no MS is IP-connected then delivery may be to a primary MS. Or, delivery may be to all MS's.

Or, delivery may be sequential, so that the message is pushed to an MS only if the previous MS did not download the pushed message within a certain time (or did not indicate the MS was read). Or, delivery may be made only to an MS or MS's having certain capability, for example MMS capability, WAP 1.2 capability, WAP 2.0 capability, color phone capability, large screen size capability, et cetera.

Optionally, the profile server 230 will send a connection check signal 235 to the SIR 240 in order to determine whether to use the own-MSISDN's of this subscriber in case some of the subscriber's MS's are connected. The SIR replies with an address signal 245 indicative of an appropriate IP address as well as other relevant information (e.g. roaming or MS capabilities)

The profile server 230 replies with a delivery rules signal 250 indicative of appropriate information (such as addresses, terminal capabilities, rules, et cetera) to the push proxy 220. If the push message may be delivered to more than one MS based on rules stored in the profile server 230, then rules for all of the own-MSISDN's belonging to the subscriber are sent to the push proxy in the delivery rules signal 250 (e.g. notification to all MS, delivery only to the first MS to answer, delivery only to EP-connected MS's, delivery to all MS's, or sequential delivery).

One preferred implementation is that the push proxy 220 may not have provided information on the type of message or the service type to the profile server 230. In this case, the profile server may return rules and MS capability for all services and for all of the own-MSISDN's belonging to the subscriber. The push proxy 220 would then have to make a rules-based decision, taking into account the MS capabilities and the service type.

Another preferred implementation is that in the rules query signal 225 the push proxy also indicates the type of message or the service type to the profile server 230. In this case, the profile server may return rules and MS capability relevant only for the requested service (and for all of the own MSISDN's belonging to the subscriber). The profile server 230 has, in this scenario, implemented a logic to select the appropriate rules and MS capability, taking into account the service type and MS capability. For example, in a particular implementation where the push proxy is an MMSC, the profile server may return only the profiles of MMS-capable MS to the MMSC. However, if the rules in the subscriber profile say that MMS should not be delivered but copied to an album, the profile server will only return the rules “copy to album belonging to MSISDN.” Another example is that, despite many MS of the same multi-SIM group may be MMS-capable, the rules in the subscriber profile may indicate that MMS can be sent only to one of the own-MSISDN. In this case, the MMSC will receive only the profile relevant to this own-MSISDN.

In step 5, the MS's are sent the notification through the GGSN's, via the push notification signals 255, 265, and 275. These push notification signals may be implemented using WAP-push protocols. As mentioned, every separate MS might be connected to a separate GGSN and/or SMSC; all MS's can typically be reached from the same SMSC, but alternatively a cluster of them could be used. The push proxy 220 will possibly have rules that if no push confirmation signal 285 is received after a push over IP, then the push proxy 220 it may resend the push notification in the form of a backup notification signal 290 via short messaging system 295.

The connection between the push proxy 220 and the profile server 230 is planned to allow various subscription and barring to push services. A similar arrangement is possible for the interface from the profile server to the SIR.

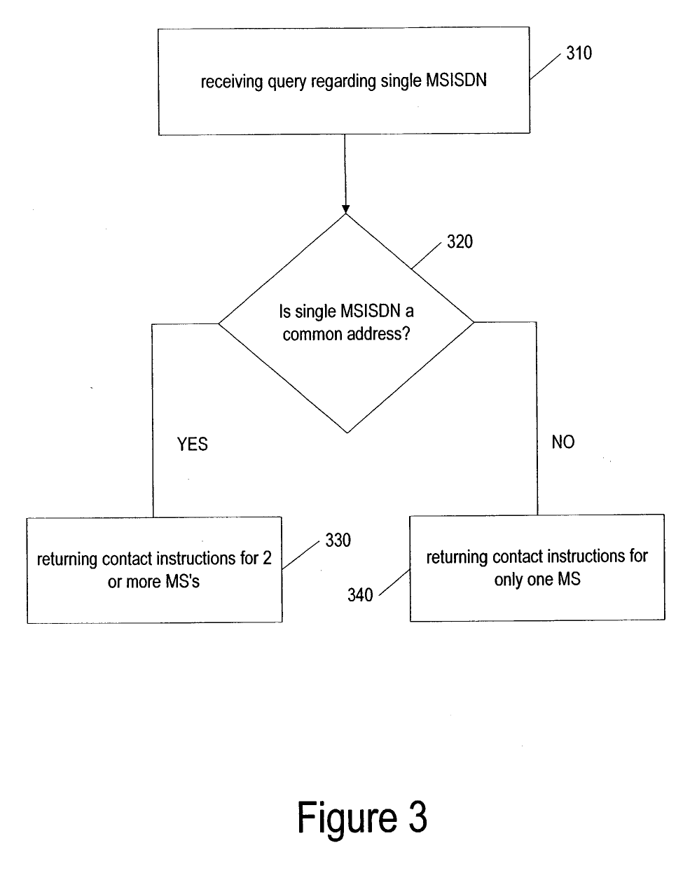

Referring now to FIG. 3, this shows a simplified flow chart of the present claimed invention, according to a preferred embodiment. The first step shown is receiving 310 a query regarding a single MSISDN. Then a determination is made as to whether or not the single MSISDN is a common address of multiple phones. If so, then it is required by the invention that contact instruction be returned 330 for two (2) or more mobile stations. However, if the single MSISDN is not a common address, then the invention requires that contact instructions be returned 340 only for one mobile station.

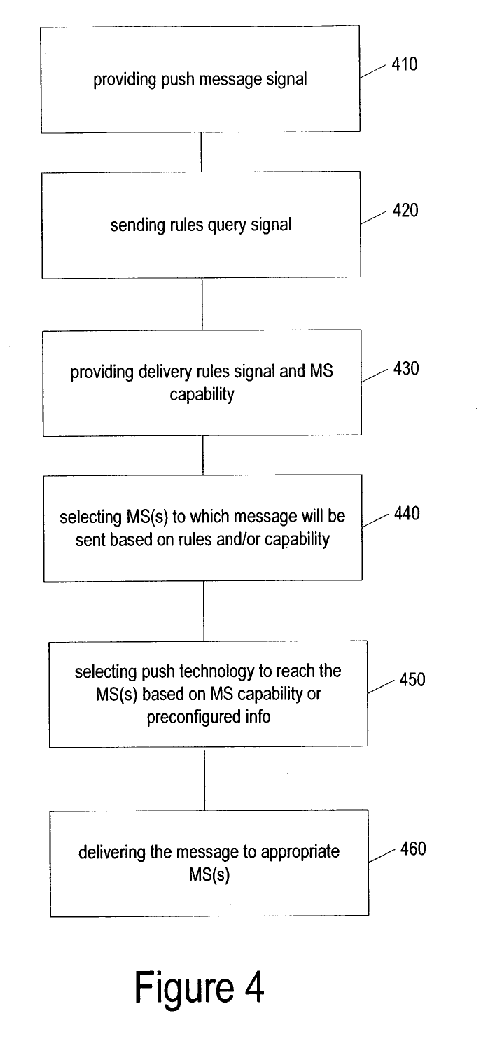

Likewise, FIG. 4 also shows a flow chart of the present claimed invention, according to a more specific preferred embodiment. A push message signal is provided 410. Then a rules query signal is sent 420. Subsequently, a delivery rules signal and MS capability is provided 430, after which, based on received rules and capability, the MS(s) to which the message will be sent are selected 440. Then, using MS capability or pre-configured information, the appropriate push technology (e.g. WAP-push, SIP, et cetera) is selected 450. Finally, the message is delivered to appropriate MS(s) 460. It should be noted that, if delivery fails, the rules may indicate the appropriate action, such as retry through a different technology (e.g. WAP-push over SMS), or store in the subscriber album, or set an alert mechanism, and attempt a new delivery later. It is to be understood that, in some cases, only the MS capability or the rules will be delivered, and this should be considered as a special case of the described embodiment.

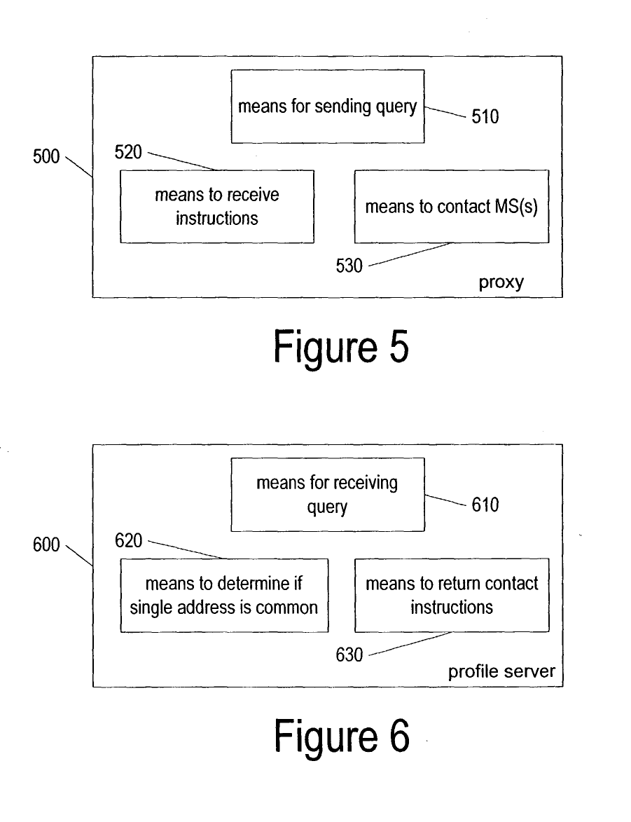

FIG. 5 illustrates a proxy 500 such as a push proxy for facilitating communication with at least one of a plurality of mobile stations that share a common address. The proxy includes means 510 for sending a query regarding a single address, means 520 to receive instructions for contacting the at least one of the plurality of mobile stations that share said common address, on condition that the single address is the common address, and means 530 for contacting the at least one of the plurality of mobile stations, in response to the instructions.

FIG. 6 illustrates a profile server 600 for communicating with at least one of a plurality of mobile stations that share a common address. The profile server includes means 610 for receiving a query regarding a single address, means 620 for determining whether said single address is the common address, and if so using means 630 to return contact instructions for contacting the at least one of the plurality of mobile stations that share the common address.

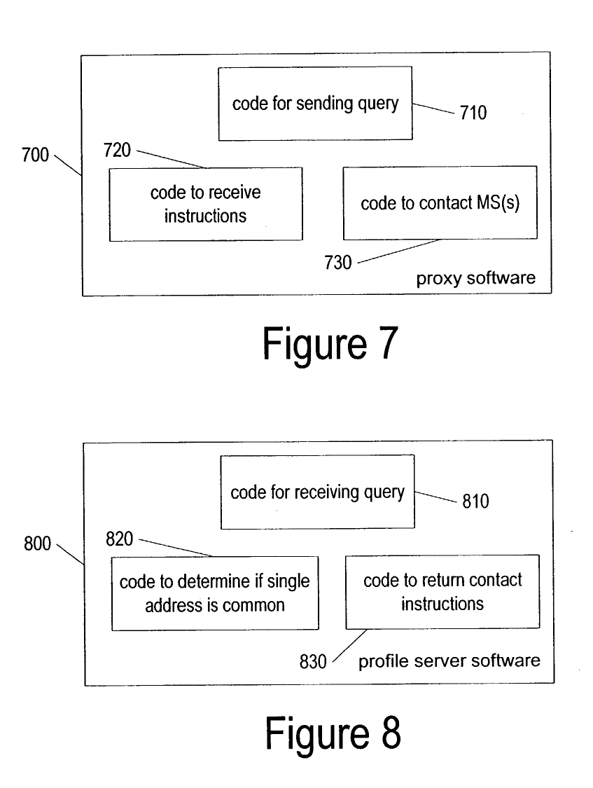

FIGS. 7 and 8 are closely related to FIGS. 5 and 6 respectively. FIG. 7 illustrates proxy software 700 for facilitating communication with at least one of a plurality of mobile stations that share a common address. The proxy software includes code 710 for sending a query regarding a single address, code 720 for receiving instructions to contact the at least one of the plurality of mobile stations that share said common address, on condition that the single address is the common address, and code 730 for contacting the at least one of the plurality of mobile stations, in response to the instructions.

FIG. 8 illustrates profile server software 800 for communicating with at least one of a plurality of mobile stations that share a common address. The profile server software includes code 810 for receiving a query regarding a single address, code 820 for determining whether said single address is the common address, and if so using code 830 to return contact instructions for contacting the at least one of the plurality of mobile stations that share the common address.

It is to be understood that all of the present Figures, and the accompanying narrative discussions of the best mode embodiments, do not purport to be rigorous treatments of the methods and devices under consideration. For example, FIG. 2 only shows certain blocks, and omits many other blocks for the sake of clarity and relevance, as will be evident to a person skilled in the art. Such a person will also understand that the blocks in the Figures, and their interactions, may be rearranged and supplemented within the scope of the present invention, and will understand that those blocks do not necessarily represent discrete hardware components; rather, the blocks can be implemented by combinations of hardware and software in a variety of different combinations and permutations. Likewise, the signals between blocks represent general cause-and-effect relationships that do not exclude intermediate interactions of various types, as will be clear to those skilled in the art.

What is claimed is:

1. A method for communicating with at least one of a plurality of mobile stations that share a common address, comprising the steps of:
receiving a query regarding a single address,
determining whether said single address is the common address, and if so returning contact instructions for contacting the at least one of the plurality of mobile stations that share said common address in response to the query, and
contacting the at least one of the plurality of mobile stations, according to the contact instructions.

2. The method of claim 1, wherein the contact instructions include respective addresses for two or more mobile stations.

3. The method of claim 1, wherein if said single address is determined not to be the common address, then the step of returning contact instructions returns contact instructions for contacting only one mobile station, using said single address.

4. The method of claim 1,
wherein the at least one common address consists of only one common address,
wherein the plurality of mobile stations includes a primary mobile station,
wherein the respective addresses include an address for the primary mobile station that is identical to the only one common address, and
wherein each address used in the method is a mobile station integrated services digital network number (MSISDN).

5. A method of providing a message to a collection of mobile terminals having a common subscriber, comprising the steps of:
providing a message signal, indicative of a message for delivery to a common address,
sending a rules query signal in response to the message signal,
providing delivery rules or mobile station capability or both in response to the rules query signal, and
delivering the message to at least one of the mobile terminals, in response to, and in a manner consistent with, rules prescribed by the delivery rules or the mobile station capability or both.

6. The method of claim 5, wherein the step of providing the delivery rules or the mobile station capabilities or both is performed by examining a subscriber profile, determining if the subscriber profile is indicative of a multi-SIM subscriber, and if so then checking how to deliver the message to the subscriber.

7. The method of claim 6, wherein the delivery rules specify that delivery shall be only to a primary mobile station within the collection.

8. The method of claim 6, wherein the delivery rules specify that notification of the message shall be to all mobile stations in the collection, with delivery of the message only to a mobile station that answers first.

9. The method of claim 6, wherein the delivery rules specify that delivery shall be only to mobile stations that are connected to a network, but if all the mobile stations that share said common address are disconnected, then delivery shall be to a primary mobile station.

10. The method of claim 6, wherein the delivery rules specify that delivery shall be to all terminals in the collection of mobile terminals.

11. The method of claim 6, wherein the delivery rules specify that notification shall be provided sequentially to one mobile terminal in the collection after another, until the message is downloaded.

12. The method of claim 6, wherein the delivery rules specify that delivery shall only be to one or more mobile stations in the collection that have a certain capability.

13. The method of claim 6, wherein the step of providing the delivery rules is performed by also consulting a subscriber identification register to determine if mobile terminals in the collection are connected to a network, and if so determining one or more respective internet protocol (IP) addresses.

14. The method of claim 5, wherein the step of delivering a message is also in response to information about what type of message is to be delivered.

15. The method of claim 5, further comprising the step of sending a backup notification signal via short messaging, if the message did not elicit a confirmation signal.

16. A system for communicating with at least one of a plurality of mobile stations that share a common address, comprising:
a proxy, for sending a query regarding a single address; and
a profile server, responsive to the query, for determining whether said single address is the common address, and if so returning contact instructions for contacting the at least one of the plurality of mobile stations that share said common address,
wherein the proxy is also for contacting the at least one of the plurality of mobile stations, in response to the contact instructions.

17. The system of claim 16, wherein the contact instructions include respective addresses for two or more mobile stations.

18. The system of claim 16, wherein the profile server is configured to return contact instructions for contacting only one of the plurality of mobile stations, using said single address, if said single address is determined not to be the common address.

19. The system of claim 16,
wherein the at least one common address consists of only one common address,
wherein the plurality of mobile stations includes a primary mobile station,
wherein the respective addresses include an address for the primary mobile station that is identical to the only one common address, and
wherein each address used in the system is a mobile station integrated services digital network number (MSISDN).

20. A system of providing a message to a collection of mobile terminals having a common subscriber, comprising:
an initiator, for providing a message signal indicative of a message targeted toward a common address;
a proxy, responsive to the message signal, for sending a rules query signal; and
a profile server, responsive to the rules query signal, for providing delivery rules or mobile station capability or both,
wherein the proxy is also for delivering the message to at least one of the mobile terminals, in response to, and in a manner consistent with, rules prescribed by the delivery rules or the mobile station capability or both.

21. The system of claim 20, wherein the profile server is furthermore for providing the delivery rules or the mobile station capabilities or both by examining a subscriber profile, determining if the subscriber profile is indicative of a multi-SIM subscriber, and if so then checking how to deliver the message to the subscriber.

22. The system of claim 21, wherein the profile server is for providing the delivery rules specifying that delivery shall be only to a primary mobile station within the collection.

23. The system of claim 21, wherein the profile server is for providing the delivery rules specifying that notification of the message shall be to all mobile stations in the collection, with delivery of the message only to a mobile station that answers first.

24. The system of claim 21, wherein the profile server is for providing the delivery rules specifying that delivery shall be only to mobile stations that are connected to a network, but if all the mobile stations that share said common address are disconnected, then delivery shall be to a primary mobile station.

25. The system of claim 21, wherein the profile server is for providing the delivery rules specifying that delivery shall be to all terminals in the collection of mobile terminals.

26. The system of claim 21, wherein the profile server is for providing the delivery rules specifying that notification shall be provided sequentially to one mobile terminal in the collection after another, until the message is downloaded.

27. The system of claim 21, wherein the profile server is for providing the delivery rules specifying that delivery shall only be to one or more mobile stations in the collection that have a certain capability.

28. The system of claim 21, wherein the profile server is for providing the delivery rules by also consulting a subscriber identification register to determine whether mobile terminals in the collection are connected to a network, and to determine respective internet protocol (IP) addresses.

29. The system of claim 20, wherein the proxy is for delivering the message also in response to information about what type of message is to be sent.

30. The system of claim 20, further comprising a short message system, and wherein the proxy is also for sending a backup notification signal to the short message system, if the message did not elicit a confirmation signal.

31. A proxy for facilitating communication with at least one of a plurality of mobile stations that share a common address, comprising:
means for sending a query regarding a single address;
means to receive instructions for contacting the at least one of the plurality of mobile stations that share said common address, on condition that the single address is the common address; and
means for contacting the at least one of the plurality of mobile stations, in response to the instructions.

32. A profile server for communicating with at least one of a plurality of mobile stations that share a common address, comprising:
means for receiving a query regarding a single address;
means for determining whether said single address is the common address, and if so returning contact instructions for contacting the at least one of the plurality of mobile stations that share said common address.

33. Proxy software for facilitating communication with at least one of a plurality of mobile stations that share a common address, comprising:
code for sending a query regarding a single address;
code to receive instructions for contacting the at least one of the plurality of mobile stations that share said common address, on condition that the single address is the common address; and
code for contacting the at least one of the plurality of mobile stations, in response to the instructions.

34. Profile server software for communicating with at least one of a plurality of mobile stations that share a common address, comprising:
code for receiving a query regarding a single address;
code for determining whether said single address is the common address, and if so returning contact instructions for contacting the at least one of the plurality of mobile stations that share said common address.
